(19) United States
(12) Patent Application Publication
(10) Pub. No.: US 2026/0205265 A1
(43) Pub. Date: Jul. 16, 2026

(54) SYSTEM AND METHOD FOR RELIABLE BIT DETECTION IN KIRCHHOFF-LAW-JOHNSON-NOISE SECURE KEY EXCHANGE SCHEMES

(71) Applicant: KOC UNIVERSITESI, Istanbul (TR)

(72) Inventor: Ertugrul BASAR, Istanbul (TR)

(73) Assignee: KOC UNIVERSITESI, Istanbul (TR)

(21) Appl. No.: 19/131,230

(22) PCT Filed: Nov. 14, 2023
(86) PCT No.: PCT/TR2023/051326

§ 371 Date: May 20, 2025

(30) Foreign Application Priority Data
Nov. 21, 2022 (TR) 2022/017558

(51) Int. Cl. H04L 9/08

(52) U.S. Cl. CPC H04L 9/0819

(57) ABSTRACT

A method for reliable bit detection in Kirchhoff-Law-Johnson-Noise key exchange schemes includes the steps of determining the bit of the second terminal by current measurements on the wire line (KH) if the bit of the first terminal is 0; determining the bit of the second terminal by voltage measurements on the wire line (KH) if the bit of the first terminal is 1, in a Kirchhoff-Law-Johnson-Noise key exchange scheme including a wire line (KH) connecting a first terminal (Tr1) to a second terminal (Tr2).

### CROSS REFERENCE TO THE RELATED APPLICATIONS

This application is the national phase entry of International Application No. PCT/TR2023/051326, filed on Nov. 14, 2023, which is based upon and claims priority to Turkish Patent Application No. 2022/017558, filed on Nov. 21, 2022, the entire contents of which are incorporated herein by reference.

### TECHNICAL FIELD

The present invention relates to a system and method for reliable bit detection in Kirchhoff-Law-Johnson-Noise secure key exchange schemes.

### BACKGROUND

Today, data transmission has become an integral part of industry, defense industry, economy, education, entertainment, and personal life. Therefore, how to ensure secure data transmission is clearly one of the most important problems of today. Many methods and algorithms have been developed in the state of the art for secure data transmission. The methods currently used are based on the principle of encrypting the data with a complex code, which is practically unbreakable with current computing capabilities, and then transmitting the data. However, as the current computing capabilities increase incrementally every day, methods for data transmission security based on data encryption are gradually losing their reliability.

With the introduction of quantum computers, which will have much higher computing capabilities than the current ones, it is certain that the aforementioned encryption methods will not be able to ensure data security. Thus, there is a need for alternative methods for ensuring data transmission security other than conditional methods such as the principle of data encryption. One of these alternative methods is quantum encryption. Here, malicious eavesdroppers (Eve) who want to listen to the communication line can be detected. Hence, when an eavesdropper is detected, data transmission is interrupted, and the transmission is continued by being moved to a different secure channel. However, quantum encryption is not feasible for use in most applications in everyday life because it involves high technology and thus is a costly solution. Another alternative method is called the Kirchhoff-Law-Johnson-Noise (KLJN) method/system. The KLJN method/system is based on classical physics and is simple in that it comprises a few resistors, keys, and a communication line (wire). Therefore, the KLJN method is one of the strongest candidates for future data security methods as it offers an effective, simple, and cost-effective solution for data transmission security. In the method/system, secure communication is established between the parties (referred to as Alice and Bob in the literature) by using the thermal noises (Johnson noises) of the resistors as a signal source. There are two identical pairs of resistors, which are denoted as R_{L} and R_{H}, at both ends of the transmission line. A pair of bits (00, 01, 10, 11) is transferred for each condition (R_{L}-R_{L}, R_{L}-R_{H}, R_{H}-R_{L}, R_{H}-R_{H}) at both ends of the transmission line. In cases where the parties (Alice and Bob) at both ends of the transmission line select different resistors (R_{L}-R_{H}, R_{H}-R_{L} cases), an intermediate mean-square noise voltage level is generated on the line. When malicious eavesdroppers want to listen to the transmission line, they will be able to measure the said intermediate mean-square noise voltage level on the transmission line by using the current and voltage values on the line. However, since malicious eavesdroppers cannot detect the contribution of the parties (Alice and Bob) to the intermediate mean-square noise voltage level, they cannot distinguish the R_{L}-R_{H}, R_{H}-R_{L} cases. Thus, an unconditional security of one bit is provided during the data transfer on the communication line.

Although KLJN methods and the systems using such methods appear to be suitable options for future data transmission security, they are not perfect. Current and voltage variances on the line and their correlation cause bit errors. In order for KLJN methods and systems to use such methods to ensure data transmission reliability as well as data transmission security, the bit error probability (BEP) must be reduced or eliminated. In this way, error-free data transmission is carried out.

Therefore, in order to ensure data reliability in KLJN methods and systems using such methods, there is a need in the art for a method and system for reliable bit detection.

### SUMMARY

A system and method for reliable bit detection in Kirchhoff-Law-Johnson-Noise secure key exchange schemes is developed to fulfill the objectives of the present invention. The method includes steps of:
determining a bit of a second terminal by current measurements on a wire line (KH) when a bit of a first terminal is 0; and
determining the bit of the second terminal by voltage measurements on the wire line (KH) when the bit of the first terminal is 1;
where the Kirchhoff-Law-Johnson-Noise key exchange scheme includes the wire line (KH) connecting the first terminal (Tr1) to the second terminal (Tr2).

### BRIEF DESCRIPTION OF THE DRAWINGS

A system and method for reliable bit detection in Kirchhoff-Law-Johnson-Noise secure key exchange schemes, which is developed to fulfill the objectives of the present invention, is illustrated in the accompanying figures and the details of the invention should be evaluated by taking into consideration the entire description, in these figures:

FIG. 1 is the schematic flow-chart of an exemplary embodiment for Kirchhoff-Law-Johnson-Noise secure key exchange schemes.

FIG. 2 is the schematic illustration of threshold-based noise voltage variance detection for KLJN schemes used in the prior art.

FIG. 3 is the schematic illustration of threshold-based noise current variance detection for KLJN schemes used in the prior art.

FIG. 4 is a graphical illustration, where the BEP performance in which both voltage and current measurements are utilized with the method and system for reliable bit detection of the present invention, is compared with the BEP performance in which only voltage measurements are considered, in the KLJN scheme.

The elements shown in the figures are each given reference numbers as follows:
Tr1: First terminal (Alice or Bob)
Tr2: Second terminal (Bob or Alice)
KH: Wire line
00, 10, 11, 01: Binary bit cases
R_{L}: Low resistance
R_{H}: High resistance
v(t): Voltage variance waveform sample
i(t): Current variance waveform sample
σ₀₀², σ₁₀², σ₁₁², σ₀₁²: Bit case variances
2T_{b}Δf: Maximum number of samples per bit

### DETAILED DESCRIPTION OF THE EMBODIMENTS

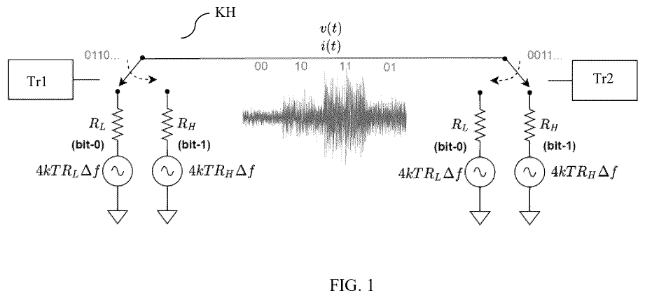

The invention relates to a system and method for reliable bit detection in Kirchhoff-Law-Johnson-Noise (KLJN) secure key exchange schemes. Here, the key exchange should also be understood as a bit exchange. For a better understanding of the invention, it is described below how Kirchhoff-Law-Johnson-Noise secure key exchange schemes work. An exemplary scheme for Kirchhoff-Law-Johnson-Noise secure key exchange is shown in FIG. 1. FIG. 1 is given as an example for a better understanding of the invention and the scope of the invention should not be limited to this example.

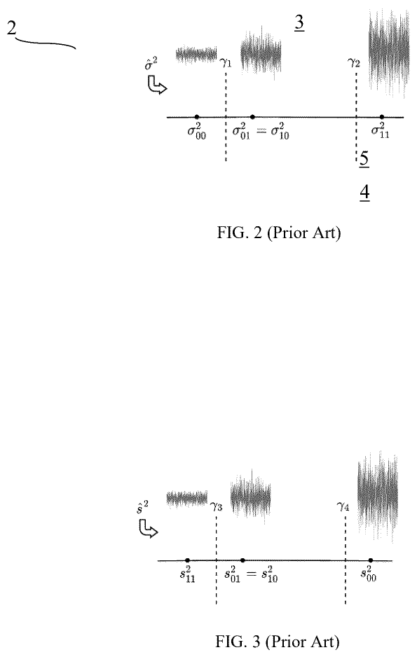

Kirchhoff-Law-Johnson-Noise secure key exchange scheme is created for two terminals (communication parties: Alice and Bob) (hereinafter referred to as Alice and Bob) to provide secure data transmission as described in background of the invention. In the scheme, there are pairs of identical resistors (R_{L} and R_{H}), namely one pair on the Alice side and one pair on the Bob side. Alice and Bob are connected to each other through a wire line (KH). Communication (bit transfer) is based on the use of Johnson-Nyquist noise (thermal noise, Johnson noise, or Nyquist noise) voltages. Here, for each bit duration (bit exchange period) of Tb seconds, according to their information bits, Alice and Bob select one of their resistors with either R_{L} or R_{H} ohms. The resistors selected by Alice and Bob are represented by RA and RB, respectively. Namely, bit 0 and bit 1 are presented by the resistors with low resistance R_{L} and high resistance R_{H}, respectively. Here, we can consider the relationship R_{H}=αR_{L}. From this perspective, the KLJN scheme can be considered as an instance of an index modulation (IM), where according to incoming information bits, the index of a resistor is selected at both sides of the link simultaneously. Alternatively, the bit transmission process of the KLJN scheme can be considered as the modulation of the noise fluctuations over the channel, where one performs a sort of IM for the noise power spectral density level, that is, for the mean-square noise voltage. The resistance selection process herein is repeated in every Tb second, where Alice and Bob perform joint voltage and current measurements. They take samples from randomly fluctuating voltage v(t) or current i(t) waveforms over the wire line (KH) at discrete-time instances for resistance selection process. In other words, Alice and Bob are equipped with sampling devices to take samples from the noise voltage and current. As shown in FIG. 2, while taking samples only from the noise voltages is a simple way to detect bits, due to the close proximity of the voltage noise variances for the cases of 00 and 01/10, statistical decision errors may occur in the system. This significantly reduces the quality and reliability of the detection of noise voltages.

On the other hand, as shown in FIG. 3, in the case of noise current-based variance detection, which is the opposite effect to noise voltage-based detection, 11 and 01/10 error events are dominant due to their close proximity. The invention has been realized to eliminate these serious problems associated with reliable bit detection.

The variance values of the following four cases of selected binary bits (00, 01, 10, 11), where the first and second bits stand for the selected bits by Alice and Bob, respectively, are given below. Here, the samples taken from the voltage waveform on the wire line (KH) will be Gaussian distributed with the following variance values according to Kirchhoff law and Johnson thermal noise formula:

$$\text{?} \qquad {σ}_{00}^{2} = 4 kT \frac{{R}_{L} {R}_{L}}{{R}_{L} + {R}_{L}} Δ f = 4 kT \frac{{R}_{L}}{2} Δ f$$

$$\begin{matrix}\text{?} & {σ}_{01}^{2} = {σ}_{10}^{2} = 4 kT \frac{{R}_{L} {R}_{H}}{{R}_{L} + {R}_{H}} Δ f = 4 {kTR}_{L} \frac{α}{1 + α} Δ f\end{matrix}$$

$$\begin{matrix}\text{?} & {σ}_{11}^{2} = 4 kT \frac{{R}_{H} {R}_{H}}{{R}_{H} + {R}_{H}} Δ f = 4 {kTR}_{L} \frac{α}{2} Δ f .\end{matrix}$$

Here σᵢ² is the noise variance values for samples taken from the voltage waveform on the wire line (KH), Δf is the noise bandwidth, k is the Boltzmann's constant, T is the temperature in degrees Kelvin, a is the ratio of large and small resistance values. The KLJN scheme has random bit errors, due to the limited number of samples taken during the specified bit duration. Similarly, the noise variances for noise current samples are obtained as follows:

$$\begin{matrix}\text{?} & {s}_{00}^{2} = 4 kT \frac{1}{{R}_{L} + {R}_{L}} Δ f = 4 kT \frac{1}{2 {R}_{L}} Δ f = {s}^{2}\end{matrix}$$

$$\begin{matrix}\text{?} & {s}_{01}^{2} = {s}_{10}^{2} = 4 kT \frac{1}{{R}_{L} + {R}_{H}} Δ f = 4 kT \frac{1}{( 1 + α ) {R}_{L}} Δ f = \frac{2 {s}^{2}}{1 + α}\end{matrix}$$

$$\begin{matrix}\text{?} & {s}_{11}^{2} = 4 kT \frac{1}{{R}_{H} + {R}_{H}} Δ f = 4 kT \frac{1}{2 α {R}_{L}} Δ f = \frac{{s}^{2}}{α} .\end{matrix}$$

Here, s² denotes the variance values for samples taken from the current waveform on the wire line (KH). Alice and Bob are subject to certain bit errors depending on the selected bit of their partner. Due to the symmetry, Alice and Bob have the same bit error probability (BEP). For the sake of clarity, we focus on Alice here.

TABLE 1
Voltage-based error events

| | | | Selected Bits (Alice/Bob) | | | |
|---|---|---|---|---|---|---|
| | | | 00 | 01 | 10 | 11 |
| Decisions | 00 | Alice | Correct | Error | — | — |
| | | | | P_{A}(01 [symbol] 00) | | |
| | | Bob | Correct | — | Error | — |
| | | | | | P_{B}(10 [symbol] 00) | |
| | 01 | Alice | Error | Correct | — | — |
| | | | P_{A}(00 [symbol] 01) | | | |
| | | Bob | — | Correct | — | Error |
| | | | | | | P_{B}(11 [symbol] 01) |
| | 10 | Alice | — | — | Correct | Error |
| | | | | | | P_{A}(11 [symbol] 10) |
| | | Bob | Error | — | Correct | — |
| | | | P_{B}(00 [symbol] 10) | | | |
| | 11 | Alice | — | — | Error | Correct |
| | | | | | P_{A}(00 [symbol] 11) | |
| | | Bob | — | Error | — | Correct |
| | | | | P_{B}(01 [symbol] 11) | | |

In Table 1, all possible error events for Alice and Bob in four possible resistance selection scenarios are shown (for the simplicity of illustration, only the cases where voltage measurements were made are considered). Here, possible resistor selections are as follows: “R_{L}-R_{L}”, “R_{L}-R_{H}”, “R_{H}-R_{L}”, “R_{H}-R_{H}”. Here, probabilities of corresponding error events for Alice and Bob are denoted by P_{A}(.) and P_{B}(.), respectively. When evaluating the BEP, all error events must be taken into account as well as secure bit exchange. There are basically two reasons for this. First, under stealth and ultra-low power communication, the cases of 00 and 11, which are non-secure bit exchange, might be exploited as well for the secure data transmission. From an encryption perspective, it would be still difficult to decrypt messages with 50% compromised bits for long enough keys, such as 256-bit keys that are widely used in general standards and protocols. Second, the cases of 00 and 11, which are non-secure bit exchange, can be mistaken as the cases of 01 and 10, which are secure bit exchange. Or vice versa, the cases of 01 and 10, which are secure bit exchange, can be mistaken as the cases of 00 and 11, which are non-secure bit exchange. For this reason, focusing only on 00/11→01/10 error events might be misleading in general.

It is assumed that during each bit duration, both Alice and Bob take samples from the thermal noise voltage v(t) and thermal noise current i(t) on the wire line (KH) to determine its thermal noise voltage v(t) and thermal noise current i(t) variances at both sides of the wire line (KH), as shown in FIG. 1.

For simplifying the examination, we will first look at the voltage samples. Denoting the kth independent noise sample by xₖ, which follows Gaussian distribution with zero mean and \hat{σ}² variance, [where σᵢ² variance has three possible values (low σ₀₀², intermediate, σ₀₁², high σ₁₁²)], noise variance estimate is obtained as follows:

$$\text{?} {\hat{σ}}^{2} = \frac{1}{N} {\sum }_{k = 1}^{N} {x}_{k}^{2} .$$

Considering the central limit theorem (CLT), the sample variance given above is Gaussian distributed with mean σᵢ² and variance 2σ₁⁴/N. The band-limited nature of the noise, which can be caused by either the use of external noise generators and/or the band-limited wire lines (KH), puts a hard limit on the number of samples N that can be taken from the line by Alice and Bob. Assuming a noise bandwidth of Δf Hz, the Wiener-Khinchin theorem states that a maximum of N=2T_{b}Δf samples can be taken per bit to ensure statistically independent samples. By using a very similar methodology, a current noise variance can be also estimated by using N current samples.

As shown in FIG. 2, considering statistical decision errors due to the randomness of noise variance estimate, the corresponding error event probabilities for the cases of 00, 11, 01, and 11 are obtained as follows:

$$\begin{matrix}\begin{matrix}\text{?} & {P}_{A} ( 00 \to 01 )\end{matrix} = {P}_{B} ( 00 \to 10 ) = P ( {\hat{σ}}^{2} > {γ}_{1} ) \\ = Q ( \frac{{γ}_{1} - {σ}_{00}^{2}}{\sqrt{2 {σ}_{00}^{4} / N}} ) ,\end{matrix}$$

$$\begin{matrix}\begin{matrix}\text{?} & {P}_{A} ( 11 \to 10 )\end{matrix} = {P}_{B} ( 11 \to 01 ) = P ( {\hat{σ}}^{2} > {γ}_{2} ) \\ = Q ( \frac{{σ}_{11}^{2} - {γ}_{2}}{\sqrt{2 {σ}_{11}^{4} / N}} ) ,\end{matrix}$$

$$\begin{matrix}\begin{matrix}\text{?} & {P}_{A} ( 01 \to 00 )\end{matrix} = {P}_{B} ( 10 \to 00 ) = P ( {\hat{σ}}^{2} > {γ}_{1} ) \\ = Q ( \frac{{σ}_{01}^{2} - {γ}_{1}}{\sqrt{2 {σ}_{01}^{4} / N}} ) ,\end{matrix}$$

$$\begin{matrix}\begin{matrix}\text{?} & {P}_{A} ( 10 \to 11 )\end{matrix} = {P}_{B} ( 01 \to 11 ) = P ( {\hat{σ}}^{2} > {γ}_{2} ) \\ = Q ( \frac{{γ}_{2} - {σ}_{01}^{2}}{\sqrt{2 {σ}_{01}^{4} / N}} ) .\end{matrix}$$

Here, [symbol] stands for the selected threshold values, Q(.) stands for the Gaussian Q-function and error events associated with the case of 00 are dominant. In light of these, considering 50% probabilities valid for the generation of bit 0 and bit 1, the BEP of the KLJN scheme is obtained as follows by only considering voltage measurements:

$$\text{?} {P}_{b} = \frac{1}{4} [ \text{} Q ( \frac{β - 1}{\sqrt{2 / N}} ) + Q ( \frac{α - κ}{α \sqrt{2 / N}} ) + Q ( \frac{( \frac{2 α}{1 + α} ) - β}{( \frac{2 α}{1 + α} ) \sqrt{2 / N}} ) + Q ( \frac{κ - ( \frac{2 α}{1 + α} )}{( \frac{2 α}{1 + α} ) \sqrt{2 / N}} ) ]$$

wherein β stands for threshold normalization and threshold values are normalized as follows: [symbol] =βσ² and [symbol] =κσ² for σ₀₀²=σ² variance. Similarly, the BEP of the KLJN scheme is obtained as follows by only considering current measurements:

$$\text{?} \text{?} = \frac{1}{4} [ \text{} Q ( \frac{1 - ξ}{\sqrt{2 / N}} ) + Q ( \frac{η - ( \frac{1}{α} )}{( \frac{1}{α} ) \sqrt{2 / N}} ) + Q ( \frac{ξ - ( \frac{2}{1 + α} )}{( \frac{2}{1 + α} ) \sqrt{2 / N}} ) + Q ( \frac{( \frac{2}{1 + α} ) - η}{( \frac{2}{1 + α} ) \sqrt{2 / N}} ) ]$$

$$\text{?} \text{indicates text missing or illegible when filed}$$

Here, the new normalized thresholds for noise current samples are defined as [symbol] =ηs² and [symbol] =ξs². And this refers the number of samples defined in a very similar way to the voltage case where N samples are used.

The method and system for reliable bit detection of the present invention is based on the fact that 00 and 11 error events are the dominant ones for voltage and current measurements, respectively. For this reason, in the method and system for reliable bit detection, Alice and Bob are allowed to select their measurement types depending on their own bits. In other words, in the invention, if Alice's (or Bob's) own bit is 0, current measurements are taken into account, or if their own bit is 1, voltage measurements are taken into account. This is because 00→01 error events are less likely for current measurements of Alice and 10→11 error events are less likely for voltage measurements of Alice, respectively. From this perspective, in the method and system for reliable bit detection, the error probability in detecting the bit transmitted from the other party (Bob's if it is Alice, Alice's if it is Bob) is minimized by utilizing the information of Alice and Bob's own bits.

TABLE 2
The procedure that shows which measurement values to use according to
the positions used in the method and system for reliable bit detection.

| | Positions | | | |
|---|---|---|---|---|
| | 00 | 11 | 01 | 10 |
| Alice | Current | Voltage | Current | Voltage |
| | Measurement | Measurement | Measurement | Measurement |
| Bob | Current | Voltage | Voltage | Current |
| | Measurement | Measurement | Measurement | Measurement |
| Error | \tilde{P}_{A} (00 [symbol] 01) | \tilde{P}_{A} (11 [symbol] 10) | \tilde{P}_{A} (01 [symbol] 00) | \tilde{P}_{A} (10 [symbol] 11) |
| Events | \tilde{P}_{B} (00 [symbol] 10) | \tilde{P}_{B} (11 [symbol] 01) | \tilde{P}_{B} (01 [symbol] 11) | \tilde{P}_{B} (10 [symbol] 00) |

In light of this information, Alice and Bob will make their decisions according to the procedures in Table 2. Accordingly, the BEP of the KLJN scheme using the method and system for reliable bit detection is as follows:

$$\text{?} {P}_{b} = \frac{1}{4} [ {\tilde{P}}_{A} ( 00 \to 01 ) + {P}_{A} ( 11 \to 10 ) + {\tilde{P}}_{A} ( 01 \to 01 ) + {P}_{A} ( 10 \to 11 ) ] .$$

$$\text{?} {P}_{b} = \frac{1}{4} [ \text{} Q ( \frac{1 - ξ}{\sqrt{2 / N}} ) + Q ( \frac{α - κ}{α \sqrt{2 / N}} ) + Q ( \frac{ξ - ( \frac{2}{1 + α} )}{( \frac{2}{1 + α} ) \sqrt{2 / N}} ) + Q ( \frac{κ - ( \frac{2 α}{1 + α} )}{( \frac{2 α}{1 + α} ) \sqrt{2 / N}} ) ]$$

wherein \tilde{P}(.) is used for the probability expression to distinguish BEP from the probabilities of voltage-based error events. Here, κ and ξ refer to normalized threshold values. As seen from this expression, bit error probability (P_{b}) of the present invention does not depend on fragile thresholds, β and η, and only consists of weaker probability terms. It can be determined by selecting the optimum κ and ξ values that minimize the bit error probability (P_{b}) for given α and N.

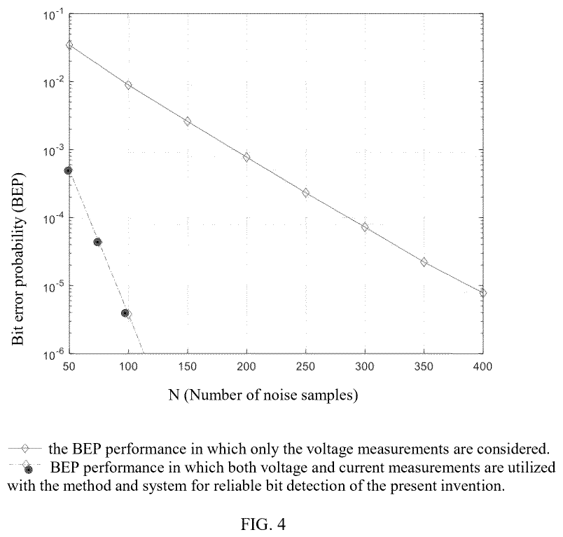

In FIG. 4, there is a graphical illustration, where the BEP performance in which both voltage and current measurements are utilized with the method and system for reliable bit detection of the present invention is compared with the BEP performance in which only voltage measurements are considered, in the KLJN scheme. In the exemplary method and system for reliable bit detection shown in the graph, for the optimization of the thresholds, N=100 is considered, which provides κ=3.1512 and ξ=0.3148.

As can be seen in FIG. 4, a much better BEP performance is obtained thanks to its adaptive sample variance calculation ability among voltage and current samples, which is performed with the method and system for reliable bit detection according to invention. In this regard, the method and system for reliable bit detection according to invention achieves lower error probabilities with a limited number of noise samples in KLJN secure key exchange schemes. Thus, with the help of the invention, the reliability and usability potential of KLJN secure key exchange schemes is increased.

A method for reliable bit detection in Kirchhoff-Law-Johnson-Noise key exchange schemes includes the steps of:
determining the bit of the second terminal by current measurements on the wire line (KH) if the bit of the first terminal is 0;
determining the bit of the second terminal by voltage measurements on the wire line (KH) if the bit of the first terminal is 1.
   in a Kirchhoff-Law-Johnson-Noise key exchange scheme including a wire line (KH) connecting a first terminal (Tr1) to a second terminal (Tr2).

A system for reliable bit detection in Kirchhoff-Law-Johnson-Noise key exchange schemes includes:
a detector, which determines the bit of the second terminal by current measurements on the wire line (KH) if the bit of the first terminal is 0, and determines the bit of the second terminal by voltage measurements on the wire line (KH) if the bit of the first terminal is 1, in a Kirchhoff-Law-Johnson-Noise key exchange scheme including a wire line (KH) connecting a first terminal (Tr1) to a second terminal (Tr2).

Here, the first terminal (Tr1) can be Alice or Bob. If the first terminal (Tr1) is Alice, the second terminal (Tr2) is Bob, or if the first terminal (Tr1) is Bob, the second terminal (Tr2) is Alice. As previously mentioned, the expression key exchange here should also be understood as a bit exchange, i.e., a data transmission.

What is claimed is:

1. A method for reliable bit detection in a Kirchhoff-Law-Johnson-Noise key exchange scheme, comprising steps of:
determining a bit of a second terminal by current measurements on a wire line (KH) when a bit of a first terminal is 0; and
determining the bit of the second terminal by voltage measurements on the wire line (KH) when the bit of the first terminal is 1;
wherein the Kirchhoff-Law-Johnson-Noise key exchange scheme comprises the wire line (KH) connecting the first terminal (Tr1) to the second terminal (Tr2).

2. A system for reliable bit detection in a Kirchhoff-Law-Johnson-Noise key exchange scheme, comprising a detector or processing unit, wherein the detector or processing unit determines a bit of a second terminal by current measurements on a wire line (KH) when a bit of a first terminal is 0, and determines the bit of the second terminal by voltage measurements on the wire line (KH) when the bit of the first terminal is 1, wherein the Kirchhoff-Law-Johnson-Noise key exchange scheme comprises the wire line (KH) connecting the first terminal (Tr1) to the second terminal (Tr2).

3. A system for reliable bit detection in a Kirchhoff-Law-Johnson-Noise key exchange scheme, comprising a processing unit, wherein the processing unit is adapted to determine a bit of a second terminal by current measurements on a wire line (KH) when a bit of a first terminal is 0, and to determine the bit of the second terminal by voltage measurements on the wire line (KH) when the bit of the first terminal is 1, wherein the Kirchhoff-Law-Johnson-Noise key exchange scheme comprises the wire line (KH) connecting the first terminal (Tr1) to the second terminal (Tr2).
